(19) United States
(12) Patent Application Publication
(10) Pub. No.: US 2026/0031105 A1
(43) Pub. Date: Jan. 29, 2026

(54) FLUOROPOLYETHER COMPOUND, LUBRICANT, AND MAGNETIC DISK

(71) Applicants: Moresco Corporation, Kobe-shi (JP); The School Corporation Kansai University, Osaka (JP)

(72) Inventors: Ryosuke SAGATA, Kobe-shi (JP); Hiroshi TANI, Suita-shi (JP)

(21) Appl. No.: 19/269,527

(22) Filed: Jul. 15, 2025

(30) Foreign Application Priority Data
Jul. 24, 2024 (JP) 2024-118828

(51) Int. Cl. G11B 5/725; C08G 65/337; C10M 107/38; C10N 40/18

(52) U.S. Cl. CPC G11B 5/7253; C08G 65/337; C10M 107/38; C10M 2213/0606; C10N 2040/18

(57) ABSTRACT

An object is to provide a lubricant whose heat resistance and adhesion to a magnetic disk are further improved, a multimerized fluoropolyether compound which is for realizing the lubricant, and a magnetic disk for which the lubricant and the fluoropolyether compound are used. The object is attained by linking two perfluoropolyether group-containing groups with a linking group having the following structure:

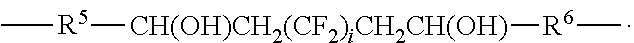

In the formula, i is an integer of 1 to 10, and R⁵ and R⁶ are each independently a hydrocarbon group having 1 to 10 carbon atoms and may each independently contain a polar group and/or an ether bond formed by substitution of at least one carbon atom in the hydrocarbon group with an oxygen atom.

This Nonprovisional application claims priority under 35 U.S.C. § 119 on Patent Application No. 2024-118828 filed in Japan on Jul. 24, 2024, the entire contents of which are hereby incorporated by reference.

### TECHNICAL FIELD

The present invention relates to a fluoropolyether compound, a lubricant, and a magnetic disk.

### BACKGROUND ART

A magnetic disk of a heat-assisted magnetic recording type (HAMR) is heated. Thus, a lubricant applied to the magnetic disk is also required to have high heat resistance.

As a technique for improving the heat resistance of a lubricant and the adhesion of the lubricant to a surface of a magnetic disk, a technique of using a fluoropolyether compound in which multiple perfluoropolyether groups are bonded via an aliphatic hydrocarbon ether group, that is, a multimerized fluoropolyether compound is known (see, for example, Patent Literatures 1 to 4).

### CITATION LIST

### Patent Literature

### [Patent Literature 1]

International Publication No. WO 2016/084781

### [Patent Literature 2]

Japanese Patent Application Publication, Tokukai, No. 2024-52300

### [Patent Literature 3]

International Publication No. WO 2024/071399

### [Patent Literature 4]

U.S. Patent Application Publication No. 2015/0235664

### SUMMARY OF INVENTION

### Technical Problem

However, in order to improve the long-term stability of a magnetic disk, it is desired that a lubricant whose heat resistance and adhesion to a magnetic disk are more improved than a conventional technique as described above be developed.

An aspect of the present invention has an object to provide a lubricant whose heat resistance and adhesion to a magnetic disk are further improved, a multimerized fluoropolyether compound which is for realizing the lubricant, a magnetic disk for which the lubricant and the fluoropolyether compound are used.

### Solution to Problem

In order to attain the object, a fluoropolyether compound in accordance with an embodiment of the present invention includes the following aspect.

A fluoropolyether compound represented by the following formula (1):

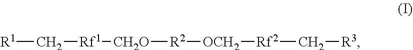

wherein:
Rf¹ and Rf² are each independently a perfluoropolyether group represented by the following formula (2):

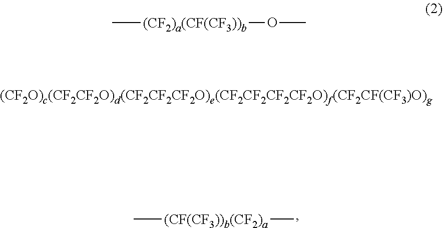

wherein c, d, e, f, and g are each independently a real number of 0 to 30, and a and b are each independently an integer of 0 to 3;
R¹ and R³ are each independently an OH group or a hydrocarbon group which has at least one OH group, which may contain an ether bond, and which may be substituted; and
R² is a group represented by the following formula (3):

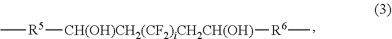

wherein i is an integer of 1 to 10, and R⁵ and R⁶ are each independently a hydrocarbon group having 1 to 10 carbon atoms and may each independently contain a polar group and/or an ether bond formed by substitution of at least one carbon atom in the hydrocarbon group with an oxygen atom.

### Advantageous Effects of Invention

An aspect of the present invention makes it possible to provide a lubricant whose heat resistance and adhesion to a magnetic disk are further improved, a multimerized fluoropolyether compound which is for realizing the lubricant, a magnetic disk for which the lubricant and the fluoropolyether compound are used.

### BRIEF DESCRIPTION OF DRAWINGS

FIG. 1 is a cross-sectional view illustrating the configuration of a magnetic disk in accordance with an embodiment of the present invention.

FIG. 2 is a cross-sectional view illustrating the configuration of a magnetic disk in accordance with an embodiment of the present invention.

### DESCRIPTION OF EMBODIMENTS

The following description will discuss embodiments of the present invention in detail. Note, however, that the present invention is not limited to the embodiments, but can be altered within this disclosure. The present invention also encompasses, in its technical scope, any embodiment derived by combining technical means disclosed in differing embodiments. Note that the expression “A to B”, which expresses a numerical range, is intended to mean “not less than A but not more than B” unless otherwise specified herein.

### [1. Fluoropolyether Compound]

A multimerized fluoropolyether compound has an increased molecular weight, and is thus unlikely to evaporate during heating. Moreover, the multimerized fluoropolyether compound has an increased amount of functional groups which interact with a surface of a magnetic disk, and thus strongly adsorbs to the magnetic disk. Therefore, a lubricant containing such a fluoropolyether compound has improved heat resistance and improved adhesion to a magnetic disk. The inventors of the present invention conducted studies to further improve the heat resistance of a lubricant containing a fluoropolyether compound and the adhesion of the lubricant to a magnetic disk. In the studies, the inventors of the present invention found that linking two perfluoropolyether group-containing groups with a linking group having a specific structure surprisingly noticeably improved the heat resistance of a lubricant and the adhesion of the lubricant to a magnetic disk. As a result, the inventors completed the present invention. Note that the term “adsorption” herein means adsorption which occurs due to an interaction caused by a chemical bond, a hydrogen bond, and an intermolecular force.

That is, a fluoropolyether compound in accordance with an embodiment of the present invention is a fluoropolyether compound represented by the following formula (1):

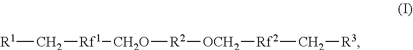

wherein:
Rf¹ and Rf² are each independently a perfluoropolyether group represented by the following formula (2):

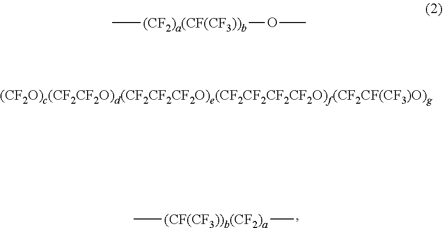

wherein c, d, e, f, and g are each independently a real number of 0 to 30, and a and b are each independently an integer of 0 to 3;
R¹ and R³ are each independently an OH group or a hydrocarbon group which has at least one OH group, which may contain an ether bond, and which may be substituted; and
R² is a group represented by the following formula (3):

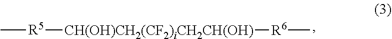

wherein i is an integer of 1 to 10, and R⁵ and R⁶ are each independently a hydrocarbon group having 1 to 10 carbon atoms and may each independently contain a polar group and/or an ether bond formed by substitution of at least one carbon atom in the hydrocarbon group with an oxygen atom.
   (Rf¹ and Rf²)

In formula (1), Rf¹ and Rf² are each independently a perfluoropolyether group represented by the above formula (2). In formula (2), c, d, e, f, and g (also referred to as c to g) only need to be each independently a real number of 0 to 30, more preferably 0 to 25. Note, however, that at least one of c to g is a real number of 1 or more. Note, here, that c to g are each an average value calculated by ¹⁹F-NMR measurement with use of JNM-ECX400 available from JEOL Ltd. In the NMR measurement, a sample itself was subjected to the measurement without use of a solvent. A known peak that indicates a skeleton structure of fluoropolyether was used as a reference for a chemical shift.

Examples of Rf¹ and Rf² include perfluoropolyether groups containing at least one selected from Demnum skeleton: —(CF₂CF₂CF₂O)ₑ—, Fomblin skeleton: —(CF₂O)_{c}(CF₂CF₂O)_{d}—, C2 skeleton: —(CF₂CF₂O)_{d}—, C4 skeleton: —(CF₂CF₂CF₂CF₂O)_{f}—, and Krytox skeleton: —(CF₂CF(CF₃)O)_{g}—.

More preferable examples of Rf¹ and Rf² include groups in which c to g in formula (2) satisfy any of the following (i) to (v). Such groups are preferable because the following configurations make a molecular chain flatter.
(i) c=a real number of 2 to 12, d=a real number of 2 to 12, and e to g=0
(ii) d=a real number of 4 to 14, and c and e to g=0
(iii) e=a real number of 2 to 12, and c, d, f, and g=0
(iv) f=a real number of 1 to 9, and c to e and g=0
(v) g=a real number of 2 to 12, and c to f=0

Note that, in the Fomblin skeleton, CF₂O and CF₂CF₂O can be randomly repeated. From the viewpoint of heat resistance, c is more preferably 0.

(R¹ and R³)

In formula (1), R¹ and R³ are each independently an OH group or a hydrocarbon group which has at least one OH group, which may contain an ether bond, and which may be substituted. R¹ and R³ preferably each independently have at least one OH group, because the adhesion of the fluoropolyether compound represented by formula (1) to a magnetic disk is improved. Note, here, that the “hydrocarbon group which may be substituted” is, in other words, a substituted or unsubstituted hydrocarbon group. Note also that the expression “which may be substituted” means that, in addition to a substitution with the at least one OH group, a substitution with a substituent other than the at least one OH group has optionally occurred.

In the substituted or unsubstituted hydrocarbon group which has at least one OH group and which may contain an ether bond (hereinafter, may be referred to as “OH group-containing hydrocarbon group”), the number of carbon atoms in the hydrocarbon group (in a case where a carbon atom(s) is/are substituted with an ether bond and/or a substituent, the hydrocarbon group in which such a substitution(s) has/have not occurred yet) is 2 to 40, more preferably 2 to 30, and more preferably 2 to 20. The hydrocarbon group may be linear or branched, and may contain a cyclic hydrocarbon group. The hydrocarbon group is preferably linear or branched, and is more preferably linear. The hydrocarbon group may be saturated or unsaturated. The number of OH groups in the OH group-containing hydrocarbon group is not limited as long as it is 1 or greater. For example, the number of OH groups is 1 to 6, more preferably 1 to 5, and even more preferably 1 to 4. From the viewpoint of adhesion to a magnetic disk, the OH group-containing hydrocarbon group preferably contains a primary OH group. The number of ether bonds contained in the OH group-containing hydrocarbon group (the number of carbon atoms which have been substituted with oxygen atoms) is, for example, 0 to 5, more preferably 1 to 4, and even more preferably 1 to 3.

In an embodiment of the present invention, in a case where the hydrocarbon group is a linear or branched hydrocarbon group, the number of carbon atoms in the hydrocarbon group (in a case where a carbon atom(s) is/are substituted with an ether bond and/or a substituent, the hydrocarbon group in which such a substitution(s) has/have not occurred yet) is 2 to 40, more preferably 2 to 30, and even more preferably 2 to 20. The hydrocarbon group may be saturated or unsaturated, but is preferably saturated. The number of OH groups contained in the OH group-containing hydrocarbon group and the number of ether bonds contained in the OH group-containing hydrocarbon group (the number of carbon atoms which have been substituted with oxygen atoms) are as described above. The linear or branched OH group-containing hydrocarbon group may contain an alkoxy group, an amino group, an alkylamino group, an amide group, a phenoxy group, an epoxy group, a nitrile group, a phosphazene group which is optionally substituted, and/or the like, in addition to the at least one OH group. Note that the amide group herein means a group having an amide bond. The amide group is not particularly limited, but is preferably, for example, an aliphatic amide group such as acetamide (—NHCOCH₃) or propionamide (—NHCOC₂H₅).

Examples of the OH group-containing hydrocarbon group include groups represented by the following formula (4).

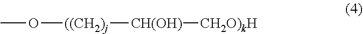

In formula (4), j is an integer of 0 to 5, and k is an integer of 1 to 3. More preferable examples of the groups represented by formula (4) include —OCH₂CH(OH)CH₂OH, —OCH₂CH(OH)CH₂OCH₂CH(OH)CH₂OH, —OCH₂CH₂CH(OH)CH₂OH, and —OCH₂CH₂CH₂CH(OH)CH₂OH.

The other examples of the OH group-containing hydrocarbon group include groups represented by the following formula (5).

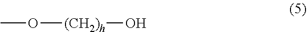

In formula (5), h is preferably an integer of 2 to 8, and more preferably an integer of 2 to 4.

In an embodiment of the present invention, in a case where the hydrocarbon group is a hydrocarbon group which contains a cyclic hydrocarbon group, the number of carbon atoms in the hydrocarbon group (in a case where a carbon atom(s) is/are substituted with an ether bond and/or a substituent, the hydrocarbon group in which such a substitution(s) has/have not occurred yet) is 3 to 40, more preferably 4 to 30, and even more preferably 4 to 20. The OH group-containing hydrocarbon group preferably has at least one OH group and at least one cyclic hydrocarbon group, because the adhesion of the fluoropolyether compound represented by formula (1) to a magnetic disk is improved. The number of cyclic hydrocarbon groups contained in the hydrocarbon group is, for example, but is not limited to, 1 to 4, more preferably 1 to 3, and even more preferably 1 to 2. The number of carbon atoms in the cyclic hydrocarbon group is, for example, 3 to 10, more preferably 3 to 8, and even more preferably 5 to 6. Examples of the cyclic hydrocarbon group include: alicyclic hydrocarbon groups such as a cyclohexyl group, a cyclohexylene group, a cyclopentyl group, and a cyclopentylene group; and aromatic hydrocarbon groups such as a phenyl group, a phenylene group, a naphthyl group, and a naphthylene group. The cyclic hydrocarbon group may be a monocyclic hydrocarbon group or a condensed polycyclic hydrocarbon group. The hydrocarbon group containing a cyclic hydrocarbon group may have a linear or branched part other than the cyclic hydrocarbon group. The hydrocarbon group which contains a cyclic hydrocarbon group can be a linear or branched hydrocarbon group which contains a cyclic hydrocarbon group in the main chain and/or a terminal(s) of the linear or branched hydrocarbon group. The linear or branched hydrocarbon group contained in the hydrocarbon group containing a cyclic hydrocarbon group is, but is not limited to, a linear or branched hydrocarbon group having 0 to 35 carbon atoms, more preferably 2 to 30 carbon atoms, and even more preferably 2 to 20 carbon atoms, may be saturated or unsaturated, and may be substituted or unsubstituted. In a case where the hydrocarbon group contains a cyclic hydrocarbon group, the number of OH groups contained in the OH group-containing hydrocarbon group and the number of ether bonds contained in the OH group-containing hydrocarbon group (the number of carbon atoms which have been substituted with oxygen atoms) are as described above.

In a case where the hydrocarbon group which contains a cyclic hydrocarbon group has a substituent other than the at least one OH group, the hydrocarbon group may be monosubstituted, disubstituted, or more multisubstituted. Examples of the OH group-containing hydrocarbon group which contains a cyclic hydrocarbon group include groups represented by the following formula (6).

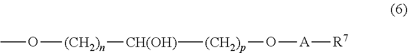

In formula (6), n and p are each independently an integer of 1 to 5; A is the cyclic hydrocarbon group; and R⁷ is a hydrogen atom, an OH group, a nitro group, an alkoxy group having 1 to 10 carbon atoms (e.g., a methoxy group, an ethoxy group, a propoxy group, or a butoxy group), a perfluoroalkyl group having 1 to 10 carbon atoms (e.g., —CF₃), an amino group, an alkylamino group (e.g., a methylamino group, a dimethylamino group, an ethylamino group, or a diethylamino group), a carboxy group, a formyl group, a carbonyl group, a sulfo group, a cyano group, an amide group (e.g., acetamide (—NHCOCH₃) or propionamide (—NHCOC₂H₅)), or a phenoxy group. The hydrocarbon group containing a cyclic hydrocarbon group is preferably substituted with any of these groups, because the adhesion of the fluoropolyether compound represented by formula (1) to a magnetic disk is further improved. Specific examples of the OH group-containing hydrocarbon group containing a cyclic hydrocarbon group include —OCH₂CH(OH)CH₂OC₆H₅, —OCH₂CH(OH)CH₂OC₁₀H₇, —OCH₂CH(OH)CH₂O(C₆H₄)NO₂, —OCH₂CH(OH)CH₂O(C₆H₄)OH, —OCH₂CH(OH)CH₂O(C₆H₄)OCH₃, —OCH₂CH(OH)CH₂O(C₆H₄)NH₂, and —OCH₂CH(OH)CH₂O(C₆H₄)OC₆H₅. R⁷ is more preferably hydrogen, an alkoxy group having 1 to 4 carbon atoms, an amino group, an amide group, or a phenoxy group. In formula (6), A may be substituted with a plurality of R⁷s.

Also the linear or branched hydrocarbon group contained in the hydrocarbon group containing a cyclic hydrocarbon group may be substituted with an alkoxy group, an amino group, an alkylamino group, an amide group, a phenoxy group, an epoxy group, a nitrile group, a phosphazene group which is optionally substituted, or the like, in addition to the substitution with the at least one OH group.

R¹ and R³ only need to be each the above-described OH group-containing hydrocarbon group, but are particularly preferably each independently a group selected from —OH, —OCH₂CH(OH)CH₂OH, —OCH₂CH(OH)CH₂OCH₂CH(OH)CH₂OH, —O(CH₂)ₕOH, and —OCH₂CH(OH)CH₂—OC₆H₄—R⁴ (h is an integer of 2 to 8, and R⁴ is hydrogen, an alkoxy group having 1 to 4 carbon atoms, an amino group, an alkylamino group, an amide group, or a phenoxy group).

### (R²)

In formula (1), R² is a group represented by the following formula (3).

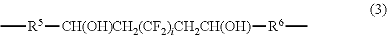

In formula (3), i is an integer of 1 to 10, and R⁵ and R⁶ are each independently a hydrocarbon group having 1 to 10 carbon atoms and may each independently contain an ether bond and/or a polar group. R² is a linking group which links two perfluoropolyether group-containing groups.

The fluoropolyether compound in accordance with an embodiment of the present invention noticeably improves the heat resistance of a lubricant in which the fluoropolyether compound is used and the adhesion of the lubricant to a magnetic disk due to R² having the above structure. A reason for this is considered as follows.

If the central part of R² is a hydrocarbon group, the affinity between the hydrocarbon group and the perfluoropolyether groups bonded to both sides of the linking group is low, and the hydrocarbon group and the perfluoropolyether groups repel each other.

However, in a case where the central part of R² is a perfluoroalkyl chain represented by “(CF₂)ᵢ” as in the present invention, the affinity between the perfluoroalkyl group and the perfluoropolyether groups bonded to both sides of the linking group is high, and repelling between the perfluoroalkyl group and the perfluoropolyether groups is reduced. This allows the linking group (R²) and OH groups contained in the linking group to more easily come close to a surface of a magnetic disk and more strongly adsorb to the surface of the magnetic disk. Thus, it is considered that the heat resistance of a lubricant and the adhesion of the lubricant to a magnetic disk are improved.

Moreover, in a case where the linking group (R²) has the perfluoroalkyl chain represented by “(CF₂)ᵢ”, it is possible to improve the chemical stability of the fluoropolyether compound, and possible to suppress pyrolysis and improve the heat resistance, as compared with a case where the linking group is a hydrocarbon group.

Furthermore, it is considered that, since the OH groups which are present at the terminals of the fluoropolyether compound and in the central part of the molecule of the fluoropolyether compound uniformly adsorb to a magnetic disk, it is possible to cover a surface of the magnetic disk with a smaller number of molecules and thus a monomolecular film thickness is reduced.

The lubricants disclosed in Patent Literatures 3 and 4 each have a structure in which a hydrocarbon group having two or more carbon atoms and an ether bond are present between “—CH(OH)—” and “(CF₂)ᵢ” in a linking group. In this case, the hydrocarbon group having two or more carbon atoms is present near the OH group. Therefore, the affinity between the hydrocarbon groups and perfluoropolyether groups bonded to both sides of the linking group (R²) is low. Thus, the linking group and the perfluoropolyether groups repel each other, and accordingly OH groups cannot come close to a surface of a disk and cannot sufficiently adsorb to the disk. Moreover, since the ether bond is also present between “—CH(OH)—” and “(CF₂)ᵢ”, the distance between “—CH(OH)—” and “(CF₂)ᵢ” is long. Therefore, the affinity between the linking group and the perfluoropolyether groups is low.

In contrast, in the fluoropolyether compound in accordance with an embodiment of the present invention, only a methylene group (—CH₂—) is present between “—CH(OH)—” and “(CF₂)ᵢ”, and neither a hydrocarbon group having two or more carbon atoms nor an ether bond is present. As a result, the distance between the OH group and “(CF₂)ᵢ” is short, and accordingly the affinity between the linking group and the perfluoropolyether groups is high. Thus, it is considered that the OH groups in the linking group (R²) more strongly adsorb to a surface of a magnetic disk and accordingly the heat resistance of a lubricant and the adhesion of the lubricant to the magnetic disk are improved.

Furthermore, for example, in the compound disclosed in Patent Literature 4, a hydrocarbon group having one carbon atom (methylene group (—CH₂—)) is not present between “—CH(OH)—” and “(CF₂)ᵢ”, and a carbon atom adjacent to the carbon atom bonding to the OH group is substituted with a fluorine atom. In this case, the fluorine atom, which has a high electronegativity, causes a decrease in electron density of the OH group in “—CH(OH)—”, and causes a decrease in adhesion to a disk.

In contrast, in R² in the fluoropolyether compound in accordance with an embodiment of the present invention, the methylene group (—CH₂—) is present between “—CH(OH)—” and “(CF₂)ᵢ”, and the carbon atom adjacent to the carbon atom bonding to the OH group is not substituted with a fluorine atom, which has a high electronegativity. Therefore, in the fluoropolyether compound in accordance with an embodiment of the present invention, the OH groups in the linking group (R²) more strongly adsorb to a surface of a magnetic disk. Thus, it is considered that the heat resistance of a lubricant and the adhesion of the lubricant to a magnetic disk are improved.

In formula (3), i only needs to be an integer of 1 to 10, but is more preferably an integer of 2 to 8 and even more preferably an integer of 2 to 6. In formula (3), R⁵ and R⁶ are each independently a hydrocarbon group having 1 to 10 carbon atoms, and may each independently contain an ether bond and/or a polar group. In an embodiment of the present invention, R⁵ and R⁶ are each independently a hydrocarbon group which has preferably 1 to 6 carbon atoms and more preferably 1 to 4 carbon atoms and which may contain a polar group, and may each independently contain an ether bond formed by substitution of at least one carbon atom in the hydrocarbon group with an oxygen atom. The hydrocarbon group may be linear or branched, and preferably linear. The hydrocarbon group may be saturated or unsaturated. The number of ether bonds contained in each of R⁵ and R⁶ is not limited, but is, for example, 0 to 4, and may be 0 to 3. From the viewpoint of the heat resistance, the number of ether bonds is preferably 0.

Examples of the polar group include an OH group, a nitro group, an alkoxy group having 1 to 10 carbon atoms (e.g., a methoxy group, an ethoxy group, a propoxy group, and a butoxy group), a perfluoroalkyl group having 1 to 10 carbon atoms (e.g., —CF₃), an amino group, an alkylamino group (e.g., a methylamino group, a dimethylamino group, an ethylamino group, and a diethylamino group), a carboxy group, a formyl group, a carbonyl group, a sulfo group, a cyano group, an amide group (e.g., acetamide (—NHCOCH₃) and propionamide (—NHCOC₂H₅)), and a phenoxy group.

In particular, R⁵ and R⁶ are each independently a hydrocarbon group having 1 to 10 carbon atoms, and may each independently contain a polar group. From the viewpoint of the adhesion, the polar group is an OH group, an amino group, an alkylamino group (e.g., a methylamino group, a dimethylamino group, an ethylamino group, or a diethylamino group), a carboxy group, a carbonyl group, a sulfo group, an amide group, or a phenoxy group (more preferably, an OH group, an amino group, an alkylamino group (e.g., a methylamino group, a dimethylamino group, an ethylamino group, or a diethylamino group), or a carboxy group), and R⁵ and R⁶ each more preferably contain no ether bond.

### Fluoropolyether Compound in Accordance with an Embodiment of the Present Invention

The fluoropolyether compound in accordance with an embodiment of the present invention is not particularly limited, provided that the fluoropolyether compound is a fluoropolyether compound represented by formula (1). More specific examples of the fluoropolyether compound include compounds 1 to 3 which are respectively represented by the following formulas.

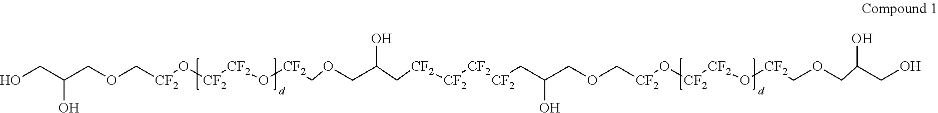

In the compound 1, d is a real number of 0 to 30, and more preferably a real number of 0 to 25.

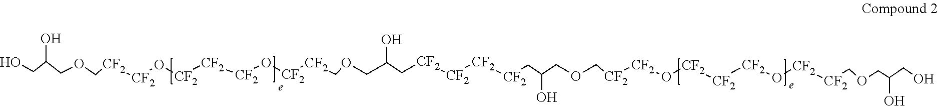

In the compound 2, e is a real number of 0 to 30, and more preferably a real number of 0 to 25.

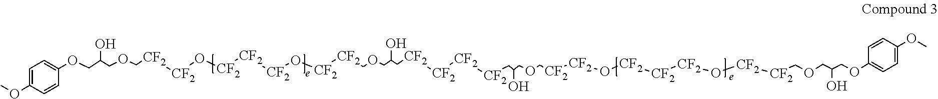

In the compound 3, e is a real number of 0 to 30, and more preferably a real number of 0 to 25.

The fluoropolyether compound in accordance with an embodiment of the present invention is preferably a liquid or solid under normal conditions, and preferably has a number average molecular weight of 600 to 10,000. From the viewpoint of the evaporativity of a lubricant, the number average molecular weight is more preferably 800 or more. The fluoropolyether compound in accordance with an embodiment of the present invention is suitably used as a lubricant. Note that the number average molecular weight herein is a value calculated by ¹H and ¹⁹F-NMR measurement with use of JNM-ECX400 available from JEOL Ltd (described earlier).

### [2. Method for Producing Fluoropolyether Compound]

A method for producing a fluoropolyether compound in accordance with an embodiment of the present invention is not particularly limited, provided that the method makes it possible to produce the above-described fluoropolyether compound.

The fluoropolyether compound in accordance with an embodiment of the present invention is obtained, for example, by reacting (i) a perfluoropolyether group-containing compound (compound X) having a hydroxy group in place of O present at the CH₂O— side terminal of the group R¹—CH₂—Rf¹—CH₂O— (or —OCH₂—Rf²—CH₂—R³) linked by —R²— in formula (1) and (ii) a compound (compound Y) which has epoxy groups at both terminals of —CH₂(CF₂)ᵢCH₂— in R² in formula (1). That is, the method for producing a fluoropolyether compound in accordance with an embodiment of the present invention includes a step of reacting the compound X and the compound Y.

In a case where R⁵ and R⁶ each differ from CH₂, the fluoropolyether compound in accordance with an embodiment of the present invention is obtained by (a) modifying, in advance, the hydroxy group present at a terminal of the perfluoropolyether group-containing compound (compound X) which has the hydroxy group in place of O present at the CH₂O— side terminal of the group R¹—CH₂—Rf¹—CH₂O— (or —OCH₂—Rf²—CH₂—R³) linked by —R²— in formula (1) and then (b) reacting the perfluoropolyether group-containing compound (compound X) and the compound (compound Y) which has epoxy groups.

Note, here, that R¹—CH₂—Rf¹—CH₂O— or —OCH₂—Rf²—CH₂—R³ and R² are as described in [1. Fluoropolyether compound].

### (Compound X)

The compound X can be produced, for example, by reacting (i) a linear fluoropolyether compound (x1) which has hydroxy groups at both terminals of —CH₂—Rf¹—CH₂— (or —CH₂—Rf²—CH₂—) and (ii) a compound (x2) which forms the group represented by R¹— (or R³—) by reacting with an OH group. A reaction temperature in this reaction is 20° C. to 90° C., and preferably 60° C. to 80° C. A reaction time is, for example, 5 hours to 20 hours, and preferably 10 hours to 15 hours. The compound (x2) is used in an amount of preferably 0.5 equivalents to 1.5 equivalents with respect to the compound (x1). Thereafter, for example, purification by column chromatography is carried out to obtain the compound X. The above reaction can be carried out in a solvent. The solvent can be t-butyl alcohol, dimethyl formaldehyde, 1,4-dioxane, dimethyl sulfoxide, dimethylacetamide, or the like. A reaction accelerator can be used for the reaction. Examples of the reaction accelerator include basic compounds such as sodium, potassium t-butoxide, and sodium hydride. Therefore, the method for producing a fluoropolyether compound may include a step of preparing the compound X. Note that, in a case where the group represented by R¹— (or R³—) is —OH, the linear fluoropolyether compound (x1) may be used as it is as the compound X.

Examples of the linear fluoropolyether compound (x1) which has hydroxy groups at both terminals of —CH₂—Rf¹—CH₂— (or —CH₂—Rf²—CH₂—) include compounds represented by HO—CH₂—Rf¹—CH₂—OH (or HO—CH₂—Rf²—CH₂—OH). The compound (x1) has a number average molecular weight of typically 300 to 4,000, more preferably 500 to 2,000, and even more preferably 600 to 1,500.

The compound (x1) has a molecular weight distribution. The compound (x1) has a molecular weight distribution (PD) of, for example, 1.0 to 1.5, preferably 1.0 to 1.3, and more preferably 1.0 to 1.1. The molecular weight distribution (PD) is indicated by weight average molecular weight/number average molecular weight. Note that the molecular weight distribution is a property value obtained with use of HPLC-8220GPC available from TOSOH CORPORATION, a column (PLgel Mixed E) available from Polymer Laboratories, an HCFC-based substitute for CFCs as an eluent, and non-functional perfluoropolyether as a reference substance.

Examples of the compound (x2) which forms the group represented by R¹— (or R³—) by reacting with an OH group include: compounds having an epoxy group as a group which reacts with the OH group; and haloalkyl alcohol represented by Z(CH₂)ₕOH (where Z is a halogen atom, and h is an integer of 2 to 8).

In a case where the hydrocarbon group of R¹— (or R³—) is a linear or branched hydrocarbon group, examples of the compounds having an epoxy group include glycidol, propylene oxide, glycidyl methyl ether, and isobutylene oxide.

In a case where the hydrocarbon group of R¹— (or R³—) is a hydrocarbon group which contains a cyclic hydrocarbon group, the compounds having an epoxy group can be, for example, compounds represented by the following formula (7).

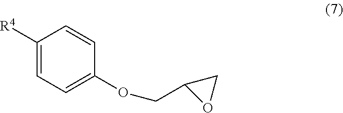

In formula (7), R⁴ is the same as R⁴ in the above description of R¹ and R³.

Specific examples of the compounds represented by formula (7) include glycidyl 4-methoxyphenyl ether, glycidyl 4-ethoxyphenyl ether, glycidyl 4-propoxyphenyl ether, glycidyl 4-butoxyphenyl ether, glycidyl 4-aminophenyl ether, glycidyl 4-methylaminophenyl ether, glycidyl 4-dimethylaminophenyl ether, glycidyl 4-ethylaminophenyl ether, glycidyl 4-diethylaminophenyl ether, glycidyl 4-acetamidophenyl ether, and glycidyl 4-propionamidophenyl ether.

In the haloalkyl alcohol represented by Z(CH₂)ₕOH, Z is a halogen atom such as chlorine, bromine, or iodine. Examples of the haloalkyl alcohol include 2-chloroethanol, 3-chloropropanol, 4-chlorobutanol, 5-chloropentanol, 6-chlorohexanol, 7-chloroheptanol, 8-chlorooctanol, 2-bromoethanol, 3-bromopropanol, 4-bromobutanol, 5-bromopentanol, 6-bromohexanol, 7-bromoheptanol, 8-bromooctanol, 2-iodoethanol, 3-iodopropanol, 4-iodobutanol, 5-iodopentanol, 6-iodohexanol, 7-iodoheptanol, and 8-iodooctanol.

For example, in a case where HO—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is used as the compound (x1) and glycidol is used as the compound (x2), HO—CH₂—CH(OH)—CH₂O—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is produced as the compound X by the reaction between the compound (x1) and the compound (x2).

In a case where HO—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is used as the compound (x1) and 2-bromoethanol is used as the compound (x2), HO—CH₂—CH₂O—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is produced as the compound X.

In a case where HO—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is used as the compound (x1) and glycidyl 4-methoxyphenyl ether is used as the compound (x2), CH₃O—C₆H₄O—CH₂—CH(OH)—CH²O—CH₂—(CF₂)ₐ(CF(CF₃))_{b}—O—(CF₂O)_{c}(CF₂CF₂O)_{d}(CF₂CF₂CF₂O)ₑ(CF₂CF₂CF₂CF₂O)_{f}(CF₂CF(CF₃)O)_{g}—(CF(CF₃))_{b}(CF₂)ₐ—CH₂—OH is produced as the compound X.

### (Compound Y)

Examples of the compound Y include compounds having epoxy groups at both terminals of —CH₂(CF₂)ᵢCH₂— in R² in formula (1). Specific examples of the compound Y include 1,4-bis(2′,3′-epoxypropyl)perfluoro-n-butane, 1,4-bis(2′,3′-epoxypropyl)perfluoro-n-propane, 1,4-bis(2′,3′-epoxypropyl)perfluoro-n-pentane, and 1,4-bis(2′,3′-epoxypropyl)perfluoro-n-hexane.

### (Step of Reacting Compound X and Compound Y)

In the present step, the compound X and the compound Y are reacted in the presence of a base. A reaction temperature is, for example, 20° C. to 90° C., and preferably 60° C. to 80° C. A reaction time is, for example, 5 hours to 20 hours, and preferably 10 hours to 15 hours. The compound Y is used in an amount of preferably 0.5 equivalents to 1.5 equivalents, and the base is used in an amount of preferably 0.5 equivalents to 2.0 equivalents, with respect to the compound X. The base can be sodium t-butoxide, potassium t-butoxide, sodium hydroxide, potassium hydroxide, sodium hydride, or the like. The above reaction can be carried out in a solvent. The solvent can be t-butanol, toluene, xylene, or the like. Thereafter, water-washing and dehydration are, for example, carried out. As a result, the fluoropolyether compound in accordance with an embodiment of the present invention is obtained.

### [3. Lubricant]

A lubricant in accordance with an embodiment of the present invention contains the above-described fluoropolyether compound in accordance with an embodiment of the present invention. The fluoropolyether compound may be used alone as the lubricant. Alternatively, the lubricant may contain the fluoropolyether compound and any other component at an arbitrary ratio, provided that the performance of the lubricant is not impaired. In a case where the fluoropolyether compound and any other component which are mixed together are used as the lubricant, the lubricant contains the fluoropolyether compound in accordance with an embodiment of the present invention in an amount of preferably more than 50 wt %, more preferably 80 wt % or more, even more preferably 90 wt % or more, and particularly preferably 99 wt % or more, with respect to the total weight of the lubricant.

Examples of the any other component include known lubricants for magnetic disks, such as Fomblin (registered trademark) Zdol (available from Solvay Solexis), Ztetraol (available from Solvay Solexis), Demnum (registered trademark) (available from Daikin Industries, Ltd.), Krytox (registered trademark) (available from Chemours), MORESCO PHOSFAROL A20H (available from MORESCO Corporation), and MORESCO PHOSFAROL D-4OH (available from MORESCO Corporation).

The lubricant in accordance with an embodiment of the present invention can be used as a lubricant for recording media to improve the sliding properties of magnetic disks. The lubricant can also be used as a lubricant for recording media (e.g., magnetic tapes), other than magnetic disks, in recording devices that involve sliding between the recording media and heads. The lubricant can also be used as a lubricant not only for recording devices but also for apparatuses having a part that involves sliding.

### [4. Magnetic Disk]

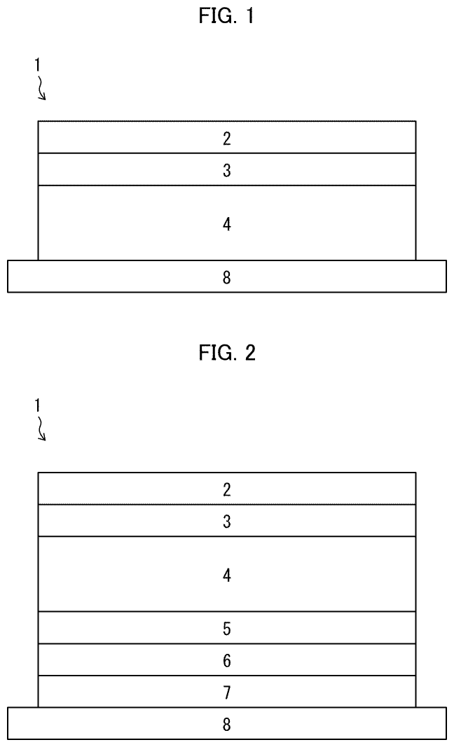

A magnetic disk 1 in accordance with an embodiment of the present invention includes, as illustrated in FIG. 1, a recording layer 4, a protective film layer (protective layer) 3, and a lubricant layer 2, which are disposed on a non-magnetic substrate 8. The lubricant layer 2 contains the above-described lubricant.

In an embodiment, as in a magnetic disk 1 illustrated in FIG. 2, a magnetic disk can include a lower layer 5 that underlies a recording layer 4, one or more soft magnetic lower layers 6 that underlie the lower layer 5, and an adhesive layer 7 that underlies the one or more soft magnetic lower layers 6. In an embodiment, all these layers can be formed on a non-magnetic substrate 8.

Each of the layers of the magnetic disk 1 except the lubricant layer 2 can contain a material that is known, in the technical field to which the present invention pertains, to be suitable for the each of the layers of the magnetic disk. Examples of the material of the recording layer 4 include: alloys of (i) elements (e.g., iron, cobalt, and nickel) that can form ferromagnetic materials and (ii) chromium, platinum, tantalum, and the like; and oxides of the alloys. Examples of the material of the protective layer 3 include carbon, Si₃N₄, SiC, and SiO₂. Examples of the material of the non-magnetic substrate 8 include aluminum alloys, glass, and polycarbonate.

### [5. Method for Producing Magnetic Disk]

A method for producing a magnetic disk in accordance with an aspect of the present invention includes a step of forming a lubricant layer by placing the lubricant in accordance with an embodiment of the present invention on an exposed surface of a protective layer of a stack of a recording layer and the protective layer.

There is no particular limitation on a method for forming the lubricant layer by placing the lubricant on the exposed surface of the protective layer of the stack of the recording layer and the protective layer. The lubricant is placed on the exposed surface of the protective layer preferably by, for example, immersing a magnetic disk in a solution obtained by diluting the lubricant with a solvent, pulling out the magnetic disk, evaporating the solvent, and then drying the lubricant. Examples of the solvent include: PF-5060, PF-5080, Novec (registered trademark) 7100, and Novec (registered trademark) 7200 each available from 3M Company; and Vertrel-XF (registered trademark) available from DuPont. The lubricant having been diluted with the solvent has a concentration of preferably 0.001 wt % to 1 wt %, more preferably 0.005 wt % to 0.5 wt %, and even more preferably 0.005 wt % to 0.1 wt %. In a case where the lubricant having been diluted with the solvent has a concentration of 0.005 wt % to 0.1 wt %, it is possible to weaken the interaction among molecules of the lubricant. This makes it easy to form a uniform lubricating film.

After the recording layer and the protective layer are formed in this order and the lubricant is placed on the exposed surface of the protective layer, ultraviolet irradiation or heat treatment may be carried out. By carrying out ultraviolet irradiation or heat treatment, it is possible to form stronger bonds between the lubricant layer and the exposed surface of the protective layer, and consequently to prevent evaporation of the lubricant due to heating. Ultraviolet irradiation is preferably carried out with use of ultraviolet light having a dominant wavelength of 185 nm or 254 nm. Heat treatment is carried out at a temperature of preferably 60° C. to 170° C., more preferably 80° C. to 170° C., and even more preferably 80° C. to 150° C.

The present invention is not limited to the embodiments above, but can be altered within the scope of the claims. The present invention also encompasses, in its technical scope, any embodiment derived by combining technical means disclosed in differing embodiments.

That is, the present invention includes the following embodiments.
<1> A fluoropolyether compound represented by the following formula (1):

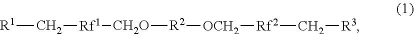

wherein:
Rf¹ and Rf² are each independently a perfluoropolyether group represented by the following formula (2):

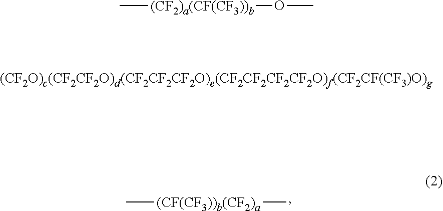

wherein c, d, e, f, and g are each independently a real number of 0 to 30, and a and b are each independently an integer of 0 to 3;
R¹ and R³ are each independently an OH group or a hydrocarbon group which has at least one OH group, which may contain an ether bond, and which may be substituted; and
R² is a group represented by the following formula (3):

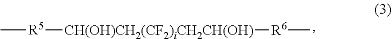

wherein i is an integer of 1 to 10, and R⁵ and R⁶ are each independently a hydrocarbon group having 1 to 10 carbon atoms and may each independently contain a polar group and/or an ether bond formed by substitution of at least one carbon atom in the hydrocarbon group with an oxygen atom.
<2> The fluoropolyether compound described in <1>, wherein R¹ and R³ are each independently a group selected from —OH, —OCH₂CH(OH)CH₂OH, —OCH₂CH(OH)CH₂OCH₂CH(OH)CH₂OH, —O(CH₂)ₕOH, and —OCH₂CH(OH)CH₂—OC₆H₄—R⁴ (h is an integer of 2 to 8, and R⁴ is hydrogen, an alkoxy group having 1 to 4 carbon atoms, an amino group, an alkylamino group, an amide group, or a phenoxy group).
<3> The fluoropolyether compound described in <1> or <2>, wherein the polar group in R⁵ and R⁶ is an OH group, an amino group, an alkylamino group, a carboxy group, a carbonyl group, a sulfo group, an amide group, or a phenoxy group.
<4> A lubricant containing a fluoropolyether compound described in any one of <1> to <3>.
<5> A magnetic disk which has a lubricant layer comprising a lubricant described in <4>.

### EXAMPLES

The present invention will be described below in more detail with reference to Examples. Note, however, that the present invention is not limited to such Examples. Note that ¹H-NMR was measured with D₂O as a reference substance and without a solvent. Note also that ¹⁹F-NMR was measured with use of, as a reference for a chemical shift, a known peak that indicates a part of a skeleton structure of fluoropolyether and without use of a solvent.

### Example 1: Synthesis of Compound 1

In an argon atmosphere, a mixture of 21 g of t-butyl alcohol, 50 g of fluoropolyether represented by HO—CH₂CF₂O(CF₂CF₂O)_{d}CF₂CH₂—OH (number average molecular weight: 981, molecular weight distribution: 1.45), 0.6 g of potassium t-butoxide, and 3.5 g of glycidol was stirred at 70° C. for 14 hours. Thereafter, an obtained product was water-washed, dehydrated, and purified by silica gel column chromatography, so that 45 g of a compound having one hydroxy group at one terminal of a perfluoropolyether group and having two hydroxy groups at the other terminal of the perfluoropolyether group was obtained. Subsequently, 45 g of this compound was dissolved in 19 g of t-butyl alcohol, and then 0.4 g of sodium t-butoxide and 5.2 g of 1,4-bis(2′,3′-epoxypropyl)perfluoro-n-butane were added. An obtained mixed solution was stirred at 70° C. for 14 hours. Thereafter, an obtained product was water-washed, dehydrated, and purified by distillation, so that 12 g of a compound 1 (number average molecular weight: 2,460) represented by the following formula was obtained.

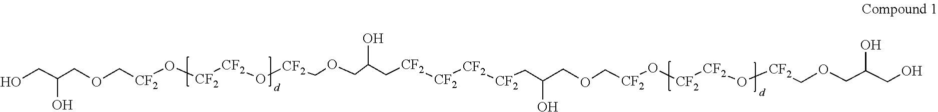

The compound 1 was a light-yellow transparent liquid, and had a density of 1.72 g/cm³ at 20° C. Results of identification of the compound 1 which was carried out by NMR are shown below.

¹⁹F-NMR (reference substance: OCF₂CF₂O in the product was regarded as −89.1 ppm)

### δ=−124.2 ppm (4F), δ=−113.0 ppm (4F), δ=−89.8 ppm (56F), δ=−78.8 ppm (8F)

d=7.0.

¹H-NMR

### δ=2.2 ppm (4H), δ=3.0 ppm to 5.0 ppm (30H)

### Example 2: Synthesis of Compound 2

The same operations as those in Example 1 were carried out, except that HO—CH₂CF₂CF₂O(CF₂CF₂CF₂O)ₑCF₂CF₂CH₂—OH (number average molecular weight: 1,081, molecular weight distribution: 1.26) was used instead of HO—CH₂CF₂O(CF₂CF₂O)_{d}CF₂CH₂—OH used in Example 1. As a result, 9 g of a compound 2 (number average molecular weight: 2,629) represented by the following formula was obtained.

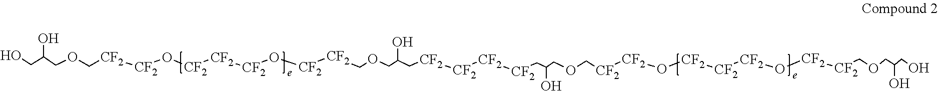

¹⁹F-NMR (reference substance: OCF₂CF₂CF₂O in the product was regarded as −129.7 ppm)

### δ=−129.7 ppm (19F), δ=−124.2 ppm (12F), δ=−113.0 ppm (4F), δ=−86.5 ppm (8F), δ=−83.7 ppm (38F)

e=4.8.

¹H-NMR

### δ=2.2 ppm (4H), δ=3.0 ppm to 5.0 ppm (30H)

### Example 3: Synthesis of Compound 3

The same operations as those in Example 1 were carried out, except that HO—CH₂CF₂CF₂O(CF₂CF₂CF₂O)ₑCF₂CF₂CH₂—OH (number average molecular weight: 1,219, molecular weight distribution: 1.25) was used instead of HO—CH₂CF₂O(CF₂CF₂O)_{d}CF₂CH₂—OH used in Example 1 and 5.8 g of glycidyl 4-methoxyphenyl ether was used instead of glycidol. As a result, 24 g of a compound having one hydroxy group at one terminal of a perfluoropolyether group and a methoxyphenyl group at the other terminal of the perfluoropolyether group was obtained, and ultimately 8 g of a compound 3 (number average molecular weight: 3,902) represented by the following formula was obtained.

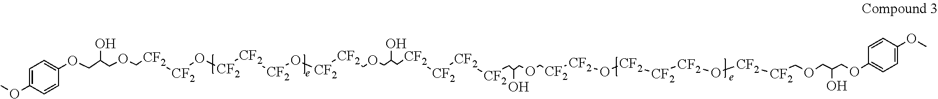

¹⁹F-NMR (reference substance: OCF₂CF₂CF₂O in the product was regarded as −129.7 ppm)

### δ=−129.7 ppm (32F), δ=−124.2 ppm (12F), δ=−113.0 ppm (4F), δ=−86.5 ppm (8F), δ=−83.7 ppm (64F)

e=8.0

¹H-NMR

### δ=2.2 ppm (4H), δ=3.0 ppm to 5.0 ppm (34H), δ=6.7 ppm (10H)

### Comparative Example 1

The same operations as those in Example 1 were carried out, except that 1,7-octadiene diepoxide was used instead of 1,4-bis(2′,3′-epoxypropyl)perfluoro-n-butane. As a result, a comparative compound 1 (number average molecular weight: 2,208) represented by the following formula was synthesized.

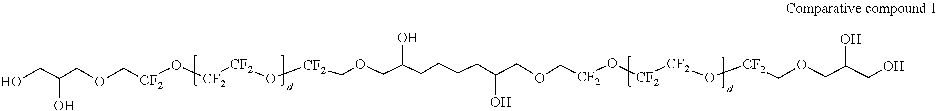

### Comparative Example 2

A comparative compound 2 (number average molecular weight: 2,846) represented by the following formula was synthesized by the method disclosed in Example 3 of Patent Literature 2 (Japanese Patent Application Publication, Tokukai, No. 2024-52300).

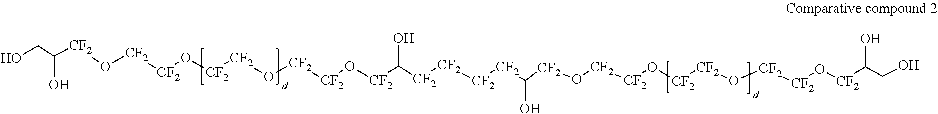

### Comparative Example 3

The same operations as those in Example 2 were carried out, except that 1,7-octadiene diepoxide was used instead of 1,4-bis(2′,3′-epoxypropyl)perfluoro-n-butane. As a result, a comparative compound 3 (number average molecular weight: 2,670) represented by the following formula was synthesized.

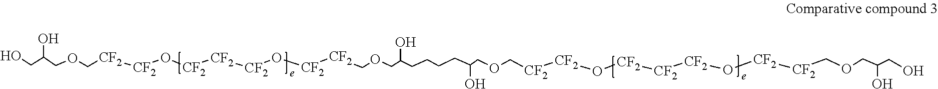

### Comparative Example 4

The same operations as those in Example 3 were carried out, except that 1,7-octadiene diepoxide was used instead of 1,4-bis(2′,3′-epoxypropyl)perfluoro-n-butane. As a result, a comparative compound 4 (number average molecular weight: 2,898) represented by the following formula was synthesized.

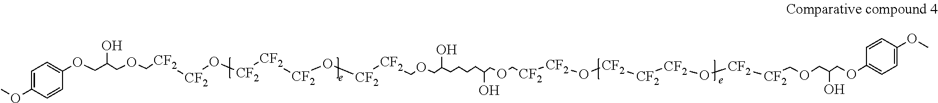

### [Measurement of Thermal Weight Loss Temperature]

A thermal weight loss temperature of the fluoropolyether compound obtained in each of Examples and Comparative Examples was measured with a thermogravimetric device (STA200, available from Hitachi High-Tech Science Corporation).

5 mg of the fluoropolyether compound obtained in each of Examples and Comparative Examples was weighed out, placed in a platinum container, and then heated to 550° C. at a temperature increase rate of 2° C./min in an air atmosphere. A temperature at the time when the weight of the fluoropolyether compound was reduced by 10% in the air atmosphere (10% weight loss temperature) was measured. Results are shown in Table 1.

### [Measurement of Monomolecular Film Thickness]

The fluoropolyether compound obtained in each of Examples and Comparative Examples was dissolved in VETREL XF available from Chemours-Mitsui Fluoroproducts Co., Ltd. such that the fluoropolyether compound had a concentration falling within the range of 0.12 wt % to 0.15 wt %.

After a part (approximately ¼) of a magnetic disk having a diameter of 2.5 inches was immersed in an obtained solution, the magnetic disk was pulled out at a speed of 2 mm/s. In this manner, the disk was prepared which had (i) a part to which a lubricant (fluoropolyether compound) was applied (applied part) as a lubricant layer and (ii) a part to which the lubricant was not applied (non-applied part). An average film thickness at the applied part was 20 Å to 50 Å.

Immediately after the disk was prepared, the disk was set on an ellipsometer, and then a change in film thickness near the boundary between the applied part and the non-applied part was measured every certain period of time at room temperature. As a film thickness at a terrace part formed, the monomolecular film thickness of the lubricant was obtained. Results are shown in Table 1.

### [Measurement of Bonding Ratio]

The fluoropolyether compound obtained in each of Examples and Comparative Examples was dissolved in VETREL XF available from Chemours-Mitsui Fluoroproducts Co., Ltd. such that the fluoropolyether compound had concentrations of 0.01 wt %, 0.02 wt %, 0.03 wt %, and 0.04 wt %.

Magnetic disks each having a diameter of 2.5 inches were immersed in respective obtained solutions for 3 minutes, and then pulled out at a speed of 2 mm/s. Thereafter, the average film thickness of the fluoropolyether compound on each of the disks was measured with an ellipsometer. This average film thickness is regarded as f Å.

Next, the disks for each of which the average film thickness was measured were immersed in respective ethanol solvents for 3 minutes, pulled out at a speed of 2 mm/s, and then left to stand still at room temperature so that the solvents were volatilized. Thereafter, the average film thickness of the fluoropolyether compound remaining on each of the disks was measured with an ellipsometer. This average film thickness is regarded as b Å.

As an index which indicates the degree of adsorption to a disk, a generally used bonding ratio was employed. The bonding ratio is expressed by the following formula.

Bonding ratio (%)=100×b/f

Results of measuring bonding ratios at the respective concentrations are shown in Table 1.

TABLE 1

| | 10% | Bonding ratio (%) | | | | Monomolecular |
|---|---|---|---|---|---|---|
| | weight loss | Application | Application | Application | Application | film |
| | temperature | concentration | concentration | concentration | concentration | thicknesses |
| | (° C.) | 0.01% | 0.02% | 0.03% | 0.04% | (Å) |
| Example 1 | 271 | 20 | 25 | 24 | 20 | 8 |
| Comparative | 229 | 1 | 1 | 1 | 1 | 9 |
| Example 1 | | | | | | |
| Comparative | 232 | 3 | 2 | 2 | 3 | 12 |
| Example 2 | | | | | | |
| Example 2 | 245 | 18 | 19 | 20 | 22 | 8.5 |
| Comparative | 233 | 1 | 1 | 1 | 1 | 9.5 |
| Example 3 | | | | | | |
| Example 3 | 291 | 7 | 8 | 8 | 10 | 9 |
| Comparative | 282 | <1 | <1 | <1 | <1 | 10 |
| Example 4 | | | | | | |

The compounds in Examples 1 to 3 are compounds in each of which a linking group (R²) that links two perfluoropolyether group-containing groups contains a perfluoroalkyl chain represented by “(CF₂)ᵢ”. The compounds in Comparative Examples 1, 3, and 4 have structures respectively corresponding to the compounds in Examples 1 to 3, but respectively differ from the compounds in Examples 1 to 3 only in that a linking group is an aliphatic hydrocarbon ether group and does not contain “(CF₂)ᵢ”. It was shown that the compounds in Examples 1 to 3 respectively had higher 10% weight loss temperatures than the compounds in Comparative Examples 1, 3, and 4. This is considered to be because, in each of Examples, since some of hydrogen atoms of an aliphatic hydrocarbon ether group in the linking group were substituted with fluorine atoms, chemical stability was improved and pyrolysis was unlikely to occur.

Moreover, it was shown that the compound in Example 1 having methylene groups (—CH₂) near OH groups in the linking group had a higher 10% weight loss temperature than the compound in Comparative Example 2 having no methylene group near OH groups and having —CF₂— near the OH groups. This is considered to be because the presence of the methylene groups (—CH₂) near the OH groups in the linking group increased the electron donating properties of the OH groups, as compared with a case where —CF₂— was present near the OH groups in the linking group, and, therefore, the intermolecular force of the fluoropolyether compound was kept high and pyrolysis was unlikely to occur.

Furthermore, it was shown that the compounds in Examples 1, 2, and 3 respectively had noticeably higher bonding ratios than the compounds in Comparative Examples 1, 3, and 4, which respectively correspond to the compounds in Examples 1, 2, and 3. This is considered to be because, in each of Examples, since some of the hydrogen atoms of the aliphatic hydrocarbon ether group in the linking group were substituted with the fluorine atoms, the affinity between the linking group and perfluoropolyether groups which were bonded to the linking group on both sides of the linking group was improved and, therefore, repelling between the linking group and the perfluoropolyether groups was suppressed and it was easy for the linking group to come close to surfaces of the disks.

Moreover, it was shown that the compounds in Examples 1, 2, and 3 respectively had thinner monomolecular film thicknesses than the compounds in Comparative Examples 1, 3, and 4, which respectively correspond to the compounds in Examples 1, 2, and 3. This is considered to be because, in each of Examples, it was possible to efficiently cover a surface of the disk with a smaller number of molecules.

In addition, it was shown that the compound in Example 1 had noticeably higher bonding ratios than the compound in Comparative Example 2 and a thinner monomolecular film thickness than the compound in Comparative Example 2. This is considered to be because the presence of the methylene groups near the OH groups in the linking group increased the electron donating properties of the OH groups, as compared with a case where —CF₂— was present near the OH groups, and, therefore, the OH groups could strongly adsorb to the surfaces of the magnetic disks.

### INDUSTRIAL APPLICABILITY

A fluoropolyether compound in accordance with an aspect of the present invention can be suitably used as a lubricant for magnetic disks.

### REFERENCE SIGNS LIST

1 Magnetic disk
2 Lubricant layer
3 Protective film layer (protective layer)
4 Recording layer
5 Lower layer
6 Soft magnetic lower layer
7 Adhesive layer
8 Non-magnetic substrate

1. A fluoropolyether compound represented by the following formula (1): 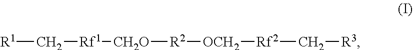
wherein:
Rf¹ and Rf² are each independently a perfluoropolyether group represented by the following formula (2): 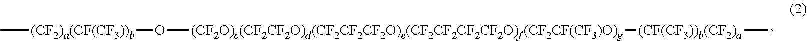
wherein c, d, e, f, and g are each independently a real number of 0 to 30, and a and b are each independently an integer of 0 to 3;
R¹ and R³ are each independently an OH group or a hydrocarbon group which has at least one OH group, which may contain an ether bond, and which may be substituted; and
R² is a group represented by the following formula (3): 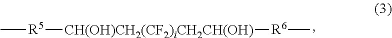
wherein i is an integer of 1 to 10, and R⁵ and R⁶ are each independently a hydrocarbon group having 1 to 10 carbon atoms and may each independently contain a polar group and/or an ether bond formed by substitution of at least one carbon atom in the hydrocarbon group with an oxygen atom.

2. The fluoropolyether compound as set forth in claim 1, wherein R¹ and R³ are each independently a group selected from —OH, —OCH₂CH(OH)CH₂OH, —OCH₂CH(OH)CH₂OCH₂CH(OH)CH₂OH, —O(CH₂)ₕOH, and —OCH₂CH(OH)CH₂—OC₆H₄—R⁴ (h is an integer of 2 to 8, and R⁴ is hydrogen, an alkoxy group having 1 to 4 carbon atoms, an amino group, an alkylamino group, an amide group, or a phenoxy group).

3. The fluoropolyether compound as set forth in claim 1, wherein the polar group in R⁵ and R⁶ is an OH group, an amino group, an alkylamino group, a carboxy group, a carbonyl group, a sulfo group, an amide group, or a phenoxy group.

4. A lubricant comprising a fluoropolyether compound recited in claim 1.

5. A magnetic disk which has a lubricant layer comprising a lubricant recited in claim 4.
